(19) United States
(12) Patent Application Publication
(10) Pub. No.: US 2006/0143324 A1
(43) Pub. Date: Jun. 29, 2006

(54) Automatic generation method and system of application program

(75) Inventors: Yasuhiko Awamoto, Shinagawa (JP); Yoshiyuki Okada, Shinagawa (JP); Mitsuru Arahata, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/094,292

(22) Filed: Mar. 31, 2005

(30) Foreign Application Priority Data
Dec. 24, 2004 (JP) 2004-374286

(51) Int. Cl. G06F 3/00

(52) U.S. Cl. 710/14

(57) ABSTRACT

This invention is to automatically generate an application program so as to conform with a request source. An information processing method according to the invention comprises: if an application program request including a model identification information is received from a terminal, selecting a module for a terminal of a model specified by the model identification information based on a model selection condition; extracting data for the selected module from a module storage; generating an application program by using the extracted data for the selected module; and transmitting the generated application program to the terminal.

### TECHNICAL FIELD OF THE INVENTION

This invention relates to an automatic generation technique of an application program.

### BACKGROUND OF THE INVENTION

At present, various terminal devices are able to connect with a network, and such terminal devices are also able to download application programs stored in servers and execute them when needs arise. As for mobile terminals such as cellular phones, models that have a Web browser, in which Java (a trademark of Sun Microsystems, Inc.) is executable, has been spread, and downloaded applets can be executed in such mobile terminals.

For instance, JP-A-2003-22184 discloses a technique to download application programs to such mobile terminals. Specifically, it discloses an application program system, which comprises a database; obtaining means for obtaining item information concerning items included in the database from the database; item designation receiving means for accepting designation of items to be displayed on a mobile terminal among items relating to the item information obtained by the obtaining means; generation means for generating an application program for causing a mobile terminal to communicate with an apparatus that can access to the database, and to access to the database through the apparatus, based on data definition information including the item information concerning the items whose designation is accepted by the item designation receiving means. Thus, although the application program according to display items designated by a user is generated in this patent publication, any viewpoint is not shown in which an application program is generated based on not the designation by the user but conditions included in the request source, for instance, models of the terminal devices and/or user attributes of the terminal devices.

For instance, when the model of the terminal device is changed, the necessary processing in the application program may be changed. For instance, although the fingerprint authentication processing is carried out in a certain model of the terminal device for the user authentication, the password authentication is carried out in another model of the terminal device, which does not have the fingerprint authentication function.

Moreover, the necessary processing might be changed, according to the user of the terminal device, specifically, user attributes, for instance. For instance, the user attributes includes the approval authority or the like. For instance, although a user who has the approval authority may carry out an approval processing, another user who does not have the approval authority never carries out the approval processing.

However, because the viewpoint in which an application program is generated based on the conditions specified by the request source is not shown in the aforementioned background art, there is a case where an application program including some functions for processings, which the request source does not carry out, might be generated. As a result, there was a problem that the communication cost necessary for the download of the application program increases in the terminal device that has a communication means with a high cost, such as the mobile terminal.

### SUMMARY OF THE INVENTION

Therefore, an object of this invention is to provide a new technique to automatically generate an application program so as to conform with a request source.

An information processing method according to a first aspect of the invention comprises: if an application program request including model identification information is received from a terminal, selecting a module (for example, a class file in Java, device driver, page data in HTML or the like) for a terminal of a model specified by the model identification information based on a model selection condition stored in a condition storage in advance; extracting data for the selected module from a module storage; generating an application program (for example, Java applet) by using the extracted data for the selected module; and transmitting the generated application program to the terminal.

Thus, because the module is selected using the model identification information, it is possible to automatically generate an application program including only modules, which may be used in the terminal. That is, data communication amount can be suppressed to an appropriate amount.

Moreover, in the first aspect of the invention, the application program request may include information to identify a processing to be carried out by the application program. In this case, the module selection condition may include a module selection condition for a processing to be carried out by the application program. Furthermore, the aforementioned selecting may include selecting a module that conforms with the information to identify the processing to be carried out by the application program, which is included in the application program request, based on the module selection condition for the processing to be carried out by the application program. As a result, for example, in a case where there are plural processings, which are selectable, it becomes possible to extract only modules necessary for the processing specified by the request source to generate an application program.

Furthermore, the application program request may include identification information of a user of the terminal, and the module selection condition may include a module selection condition for a user attribute (for example, authority the user has or the like) of the terminal. In this case, the aforementioned selecting may include referring to a user information storage storing an user attribute for each user to identify a user attribute corresponding to the identification information of the user of the terminal, which is included in the application program request; and selecting a module that conforms with the identified user attribute, based on the module selection condition for the user attribute of the terminal. As a result, it becomes possible to extract only modules conforming with the user attributes of the request source to generate an application program.

Furthermore, the aforementioned module selection condition may include a module selection condition for a function that a terminal has (for example, technical specification of the terminal, existence of peripheral devices, or the like). In this case, the aforementioned selecting may comprise: referring to a model information storage storing information concerning a function that the terminal has for each model to identify a function that the terminal of the model identified by the model identification information has; and selecting a module that conforms with the identified function, based on the module selection condition for the function that the terminal has. As a result, it becomes possible to extract only modules conforming with the function that the terminal has, for example, to generate an application program.

An information processing method according to a second aspect of the invention comprises: if an application program request including identification information of a user of a terminal is received from the terminal, referring to a user information storage storing a user attribute for each user to identify a user attribute corresponding to the identification information of the user of the terminal, which is included in the application program request; selecting a module that conforms with the user attribute of the user of the terminal, based on a module selection condition stored in a condition storage in advance; extracting data for the selected module from a module storage; generating an application program by using the extracted data for the selected module; and transmitting the generated application program to the terminal.

Thus, because modules are selected using the user attributes, it is possible to generate an application program including only modules conforming with the user attribute. That is, data communication amount can be suppressed to an appropriate amount.

An information processing method according to a third aspect of the invention is executed by a client terminal and comprises: transmitting an application program acquisition request including a designation of a processing to be carried out by an application program, identification information of a model of the client terminal, and identification information of a user of the client terminal, to a server; receiving from the server, an application program to carry out the designated processing, which conforms with a model identified by the identification information of the model of the client terminal, and a user attribute identified by the identification information of the user of the client terminal, and storing it into a storage device; and executing the designated processing by using a function that the client terminal has and is identified by the model, by the application program.

Thus, by transmitting an application program acquisition request including the designation of the processing, the identification information of the model of the terminal, and the identification information of the user of the terminal, it is possible to download an application program including only modules conforming with the request source from the server. That is, data communication amount can be suppressed to an appropriate amount.

A program causing a computer to execute the information processing method according to this invention can be created, and the program is stored in a storage medium or storage device, such as a flexible disk, CD-ROM, magneto-optical disk, semiconductor memory, or hard disk. In addition, it may be distributed as digital signals via a network. Incidentally, intermediate data during processing is temporarily stored in a storage device such as a memory in a computer.

### BRIEF DESCRIPTION OF THE DRAWINGS

FIG. 1 is a system outline diagram in an embodiment of this invention;

FIG. 2 is a functional block diagram of a server;

FIG. 3 is a diagram showing a data example of a user attribute table;

FIG. 4 is a diagram showing a data example of a function table;

FIG. 5 is a diagram showing a processing flow between a mobile terminal and a server;

FIG. 6 is a diagram showing an example of a processing designation screen;

FIG. 7 is a diagram showing an example of an HTML file to achieve the example of the screen in FIG. 6;

FIG. 8 is a diagram showing a data example of an HTTP request transmitted from the mobile terminal to the server;

FIG. 9 is a diagram showing a processing flow of an application generation processing by the server;

FIG. 10 is a diagram showing a data example of a module table;

FIG. 11 is a schematic diagram of a processing to generate an application program from modules;

FIG. 12 is a diagram showing an example of an application generation notification screen;

FIG. 13 is a diagram showing an example of a menu screen;

FIG. 14 is a diagram showing an example of a travel expense settlement application screen;

FIG. 15 is a diagram showing an example of a travel expense settlement application screen after identifying a departure station and an arrival station; and

FIG. 16 is a functional block diagram of a computer.

### DETAILED DESCRIPTION OF THE PREFERRED EMBODIMENTS

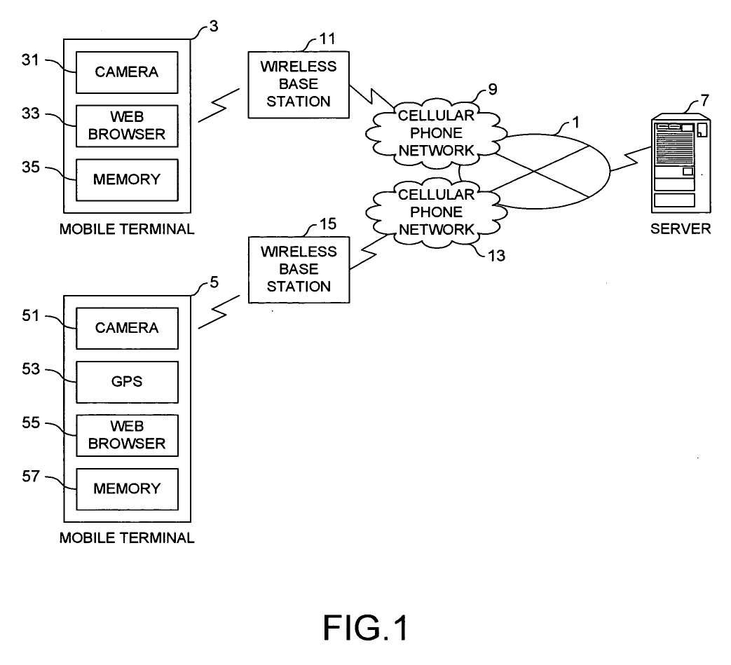

FIG. 1 shows a system outline according to one embodiment of this invention. A server 7 is connected with a network 1 such as the Internet. A mobile terminal 3 that has functions of a camera 31, a Web browser 33, a memory 35, and the like, is connected with the network 1 through a wireless base station 11 and a cellular phone network 9. Moreover, a mobile terminal 5 that has functions of a camera 51, a GPS (Global Positioning System) 53, a Web browser 55, a memory 57, and the like, is connected with the network 1 through a wireless base station 15 and a cellular phone network 13. Incidentally, in this embodiment, although an example is shown in which two mobile terminals of the mobile terminals 3 and 5 are connected with the network 1, the mobile terminal to be connected with the network 1 is not limited to these terminals. Moreover, the existence of the relationship between the mobile terminals does not influence this embodiment.

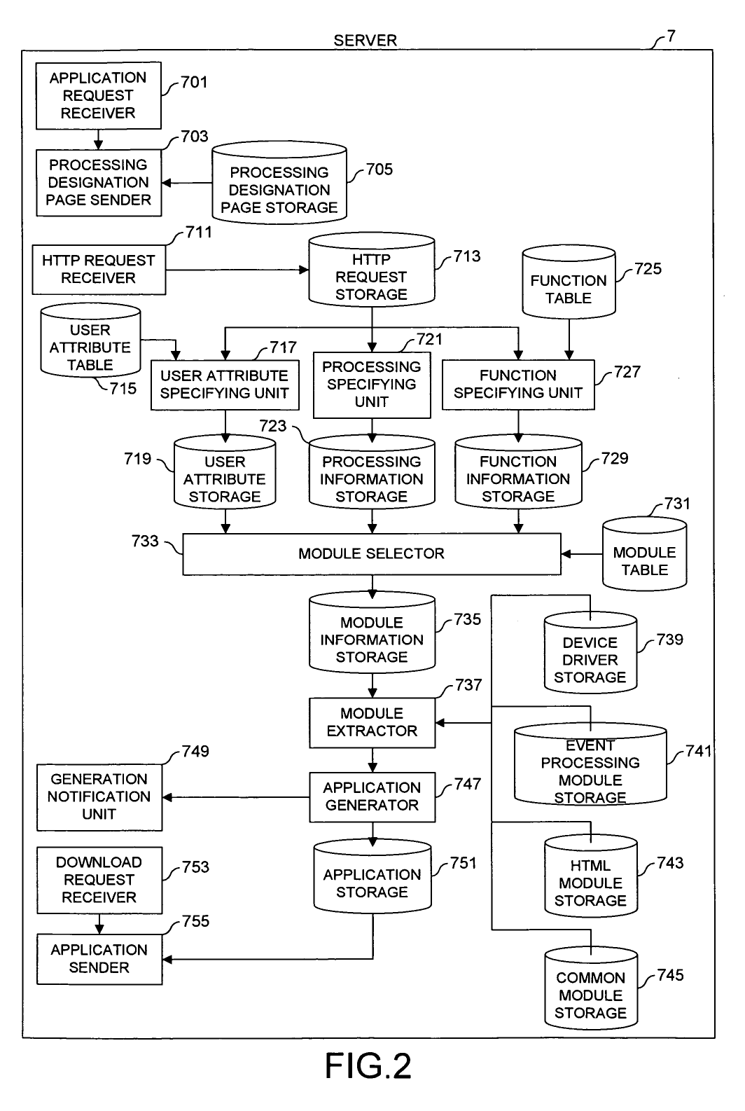

FIG. 2 shows a functional block diagram of the server 7. As shown in FIG. 2, the server 7 includes an application request receiver 701, a processing designation page sender 703, a processing designation page storage 705, an HTTP request receiver 711, an HTTP request storage 713, a user attribute table 715, a user attribute specifying unit 717, a user attribute storage 719, a processing specifying unit 721, a processing information storage 723, a function table 725, a function specifying unit 727, a function information storage 729, a module table 731, a module selector 733, a module information storage 735, a module extractor 737, a device driver storage 739, an event processing module storage 741, an HTML module storage 743, a common module storage 745, an application generator 747, a generation notification unit 749, an application storage 751, a download request receiver 753, and an application sender 755. The application request receiver 701 receives an application request from the mobile terminal, and notifies the receipt of the request to the processing designation page sender 703. When the receipt of the application request is notified from the application request receiver 701, the processing designation page sender 703 sends the mobile terminal processing designation page data read out from the processing designation page storage 705. The HTTP request receiver 711 stores an HTTP request received from the mobile terminal into the HTTP request storage 713. The user attribute specifying unit 717 carries out a processing, accessing to the HTTP request storage 713 and the user attribute table 715, and stores the processing result into the user attribute storage 719. The processing specifying unit 721 carries out a processing, accessing to the HTTP request storage 713, and stores the processing result into the processing information storage 723. The function specifying unit 727 carries out a processing, accessing to the HTTP request storage 713 and the function table 725, and stores the processing result into the function information storage 729. The module selector 733 carries out a processing, accessing to the user attribute storage 719, the processing information storage 723, the function information storage 729, and the module table 731, and stores the processing result into the module information storage 735. The Module extractor 737 extracts data from the device driver storage 739, the event processing module storage 741, the HTML module storage 743, and the common module storage 745, accessing to the module information storage 735, and outputs the extracted data to the application generator 747. The application generator 747 carries out a processing, using the data extracted by the module extractor 737, stores the processing result into the application storage 751, and notifies the generation completion of the application program to the generation notification unit 749. The generation notification unit 749 transmits a generation notice to the mobile terminal, when the generation completion of the application program is notified from the application generator 747. The download request receiver 753 receives a download request from the mobile terminal, and notifies the receipt of the request to the application sender 755. When the application sender 755 receives the notice from the download request receiver 753, it sends the mobile terminal data of the application read out from the application storage 751.

It is necessary to store data beforehand into the processing designation page storage 705, the user attribute table 715, the function table 725, the module table 731, the device driver storage 739, the event processing module storage 741, the HTML module storage 743, and the common module storage 745 in the server 7.

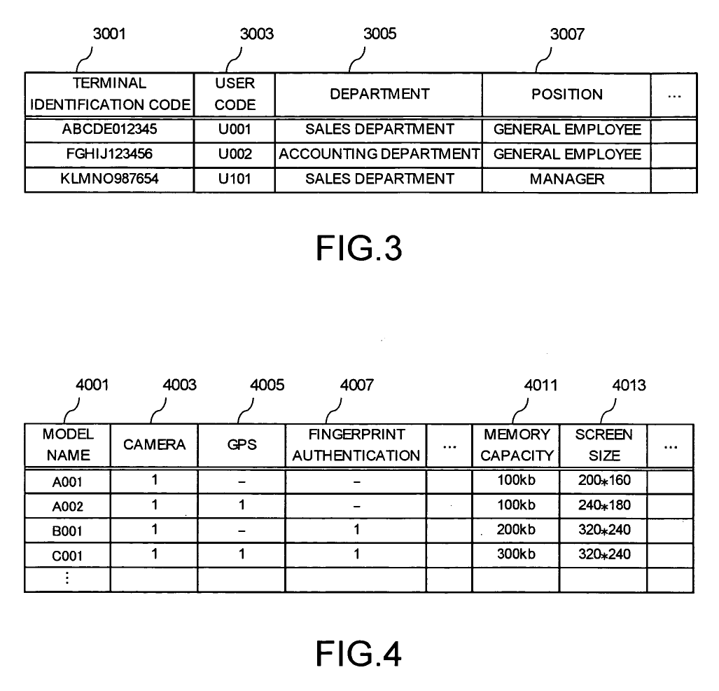

FIG. 3 shows an example of the user attribute table 715. In the example shown in FIG. 3, the user attribute table 715 includes a column 3001 of a terminal identification code, a column 3003 of a user code, a column 3005 of a department in a company, and a column 3007 of a position in the company.

FIG. 4 shows an example of the function table 725. In the example shown in FIG. 4, the function table 725 includes a column 4001 of a model name, a column 4003 of a camera, a column 4005 of a GPS, a column 4007 of a fingerprint authentication, a column 4011 of a memory capacity, and a column 4013 of a screen size. For instance, the data in the column 4003 of the camera, the column 4005 of the GPS or the column 4007 of the fingerprint authentication shows whether or not the mobile terminal has the device (i.e. function). In the example of FIG. 4, it is shown that the model whose data in the column of the GPS is “1” has the GPS function, for instance. Moreover, the data in the column 4011 of the memory capacity or the column 4013 of the screen size is data representing technical specification of the model, for instance. In the example of FIG. 4, it is shown that the memory capacity that the terminal of model A002 has, for instance, is 100 kb. Incidentally, as for the data of the camera, the GPS or the fingerprint authentication, there is a case where not the existence of the device (i.e. function) but the technical specification of the device is included.

The module table 731, the processing designation page storage 705, the device driver storage 739, the event processing module storage 741, the HTML module storage 743, and the common module storage 745 are described in the following explanation for the processing.

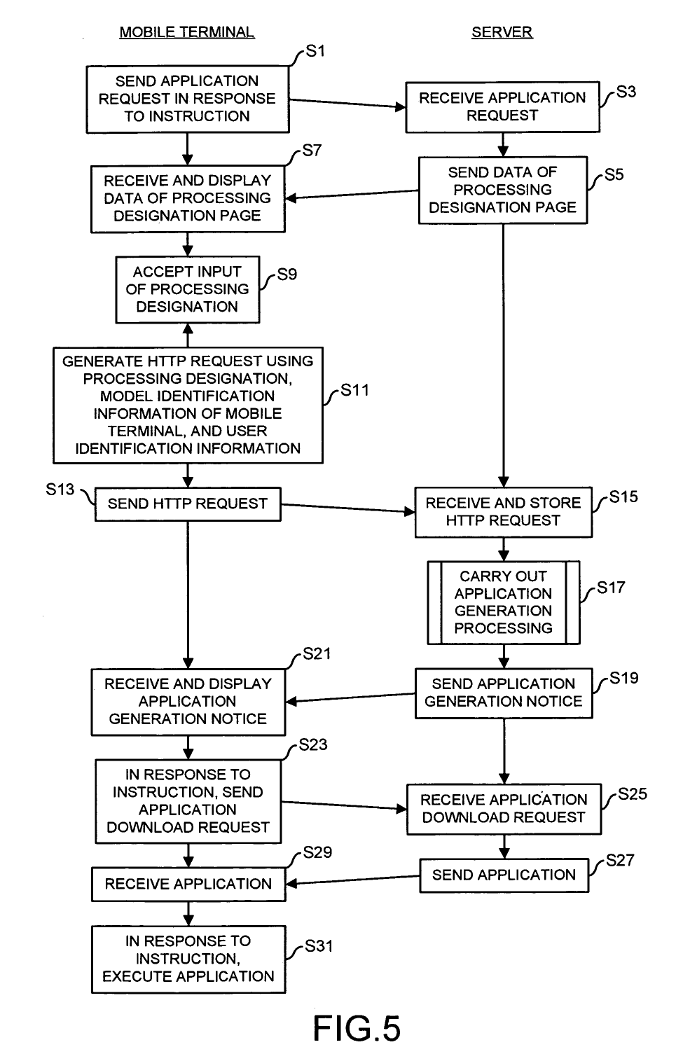

Next, a processing in this embodiment will be explained using FIG. 5. Here, an example in which the mobile terminal 5 that has functions of the camera 51, the GPS 53, the Web browser 55, the memory 57, and the like and the server 7 carry out a processing, is explained. First of all, when the mobile terminal 5 accepts an instruction for the application generation from the user, it transmits an application request to the server 7 (step S1). For instance, the application request uses the GET method of HTTP (Hyper Text Transfer Protocol) When the application request receiver 701 of the server 7 receives the application request from the mobile terminal 5 (step S3), it notifies the receipt of the application request to the processing designation page sender 703. The processing designation page sender 703 that received the notice reads out data of a processing designation page, which is used for designation of a processing to be carried out by the application program, and is stored in the processing designation page storage 705 beforehand, and transmits the read data to the mobile terminal 5 (step S5). The mobile terminal 5 receives the data of the processing designation page from the server 7, and displays the processing designation page by using the Web browser 55, for instance (step S7).

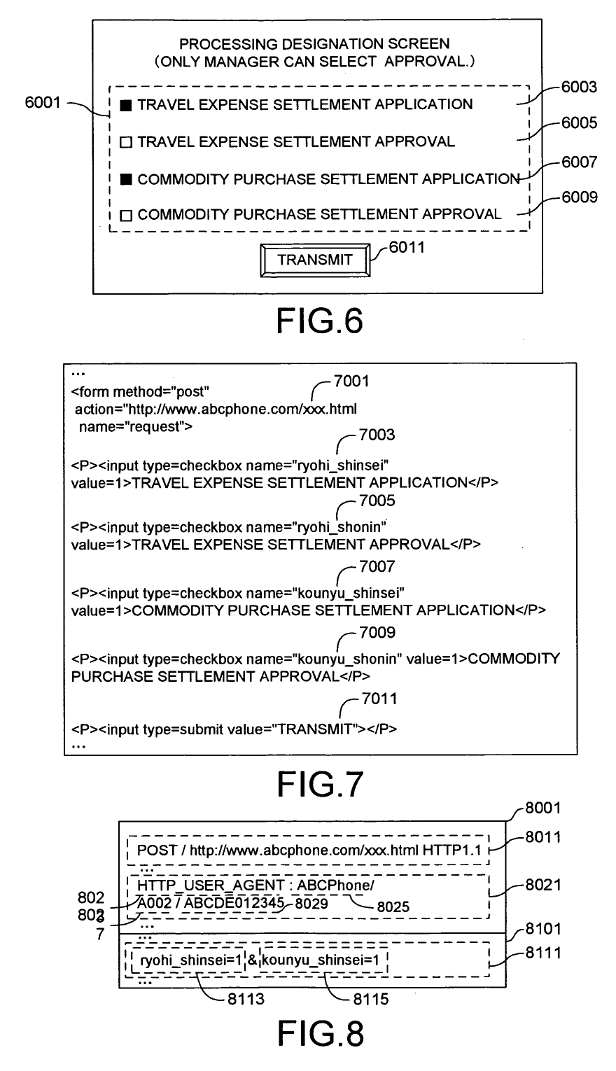

An example of a screen displayed at the step S7 is explained using FIG. 6. The example of the screen shown in FIG. 6 is an input form to prompt a user to input a processing, for instance, and it includes a selection column 6001 of the processing and a “transmit” button 6011. The selection column 6001 of the processing is used to transmit the designation of the processing to be carried out by the application requested by the user, to the server, and the column 6001 includes names of the processings and check boxes to select the processing. In this embodiment, the user is made to select processings from a travel expense settlement application 6003, a travel expense settlement approval 6005, a commodity purchase settlement application 6007, and a commodity purchase settlement approval 6009. Incidentally, the designation of the processing is not limited to one. It is also possible to designate plural processings.

An HTML file to achieve the example of the screen as shown in FIG. 6 includes source data as shown in FIG. 7, for instance. A form tag 7001 defines that a Web browser 55 transmits data by using the POST method of the HTTP, and the URL (Uniformed Resource Locator) of the destination. Input tags 7003 to 7009 whose type attribute is “checkbox” cause the Web browser 55 to display a check box corresponding to the name of the processing. The name of the processing corresponding to the input tag is described following the input tag. When the check box is checked, the Web browser 55 sets data in a form “a value of the name attribute=a value of the value attribute”. For instance, in the input tag 7003 corresponding to the check box of the travel expense settlement application 6003, the value of the name attribute is “ryohi_shinsei” and the value of the value attribute is “1”. Therefore, when the check box of the travel expense settlement application 6003 is checked, the Web browser 55 sets data of “ryohi_shinsei=1”. The input tag 7011 whose type attribute is “submit” causes the Web browser 55 to display the transmit button 6011. Moreover, it is defined that when the transmit button 6011 is clicked, data set by the Web browser 55 based on the input to the input form is transmitted to the destination determined by the form tag.

Returning to the explanation of the processing shown in FIG. 5, when the user checks off necessary check boxes among from the selection column 6001 of the processing, and clicks the transmit button 6011, the mobile terminal 5 accepts the designation of the processing from the user (step S9). Incidentally, the mobile terminal 5 may hold data of the processing designation page beforehand, and the processing designation page may be displayed first without carrying out the processing from the application request at the step S1 to data receipt of the processing designation page at the step S7, and then, the designation of the processing may be accepted from the user.

The mobile terminal 5 generates an HTTP request by using information on the designation of the processing accepted from the user, information to identify the model of the mobile terminal 5, and information to identify the user of the mobile terminal 5 (step S11). The generated HTTP request includes data as shown in FIG. 8, for instance. As shown in FIG. 8, the data of the HTTP request includes a message header 8001, and a message body 8101, and the message header 8001 includes a request line 8011 and a header field 8021. The request line 8011 defines that the request is transmitted by using the POST method of the HTTP, and the URL of the destination, and the version of the HTTP being used. The header field 8021 includes data including information to identify the model of the mobile terminal, and information to identify the user of the mobile terminal, and specifically data using the environment variable HTTP_USER_AGENT of the HTTP. In the data example shown in FIG. 8, the header field 8021 includes a name 8023 of the environment variable, a communication carrier name 8025, a model name 8027, and a terminal identification code 8029. In this embodiment, for instance, the model name 8027 is used to identify the model of the terminal, and for instance, the terminal identification code 8029 is used to identify the terminal user. The mobile terminal 5 holds the communication carrier name 8025, the model name 8027, and the terminal identification code 8029 beforehand, and when the HTTP request is generated, such information are automatically attached. Moreover, the message body 8101 includes information including the designation of the processing, which was accepted from the user, and specifically processing designation data 8111 that the Web browser 55 set based on the input to the aforementioned input form. In the example of FIG. 8, the processing designation data 8111 includes data 8113 representing the travel expense settlement application was selected and data 8115 representing the commodity purchase settlement application was selected. Incidentally, in FIG. 8, at least either of information incorporated into the header field 8021 and information incorporated into the message body 8101 may be incorporated into the request line 8011.

The mobile terminal 5 transmits the generated HTTP request to the server 7 (step S13). The HTTP request receiver 711 of the server 7 receives the HTTP request from the mobile terminal 5, and stores it into the HTTP request storage 713 (step S15). Afterwards, the application generation processing explained later is carried out (step S17).

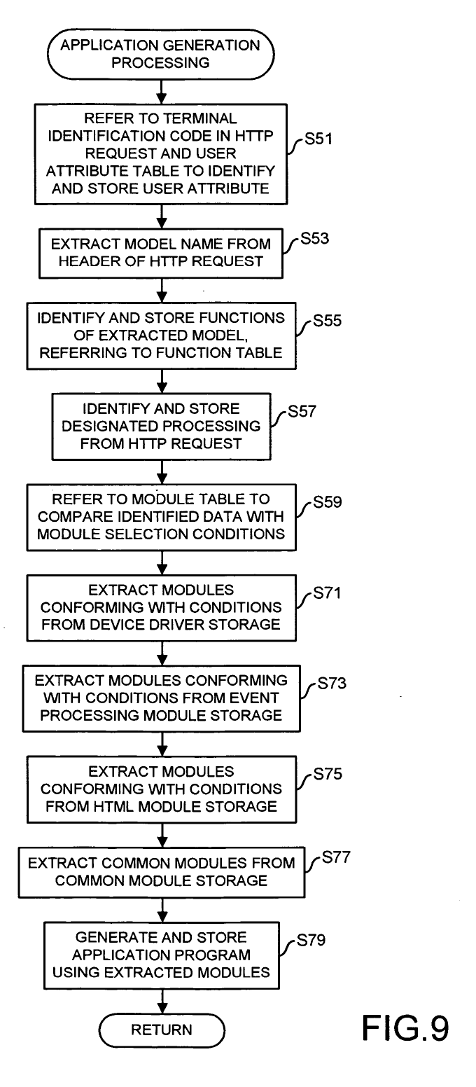

Next, the application generation processing at the step S17 is explained using FIG. 9. The user attribute specifying unit 717 specifies an attribute of the user who is requesting the application, referring to the terminal identification code 8029 included in the HTTP request stored in the HTTP request storage 713 and the user attribute table 715 (step S51). In this embodiment, when the terminal identification code 8029 included in the HTTP request is “ABCDE012345”, it refers to the user attribute table 715, and identifies that the user code of the user of the mobile terminal 5 that transmits the HTTP request is “U001”, the department is “sales department”, and the position is “general employee”. Then, the identified attributes of the user are stored into the user attribute storage 719.

Moreover, the function specifying unit 727 extracts the model name 8027 of the mobile terminal 5 included in the HTTP request, accessing to the HTTP request stored in the HTTP request storage 713 (step S53). Next, it refers to the function table 725 to identify functions that the mobile terminal of the model corresponding to the extracted model name 8027 has (step S55). In this embodiment, when the model name 8027 is “A002”, it refers to the function table 725, and identifies that the mobile terminal 5 that transmitted the HTTP request has the “camera” function and the “GPS” function, “memory capacity” of the mobile terminal 5 is “100 kb”, and “screen size” is “240*180”. Then, information of the specified functions is stored into the function information storage 729. Incidentally, the communication carrier name 8025 of the mobile terminal 5 is additionally extracted from the HTTP request if necessary, and it is used to identify the functions.

In addition, the processing specifying unit 721 identifies a processing that was designated by the user, referring to the HTTP request stored in the HTTP request storage 713 (step S57). In this embodiment, because the HTTP request includes data 8113 representing the travel expense settlement application was selected and data 8115 representing the commodity purchase settlement application was selected, it identifies that the user designated two processings. Then, it stores information of the identified processings stored into the processing information storage 723. Incidentally, the step S51, step S53, step S55, and step S57 can be independently executed respectively, and it is also possible to execute in parallel, and replace the processing order.

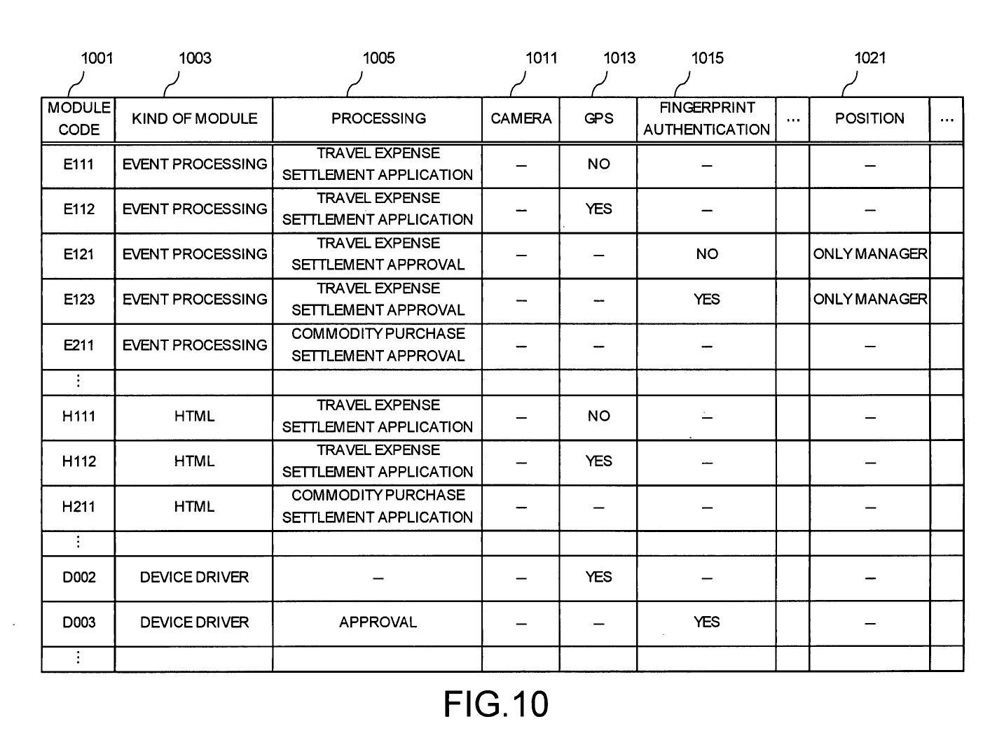

The module selector 733 identifies modules conforming with conditions, referring to the user attribute storage 719, the processing information storage 723, the function information storage 729, and the module table 731 (step S59). FIG. 10 shows an example of the module table 731. In the example shown in FIG. 10, the module table 731 includes a column 1001 of a module code, a column 1003 of a kind of the module, a column 1005 of the processing, a column 1011 of the camera, a column 1013 of the GPS, a column 1015 of the fingerprint authentication, and a column 1021 of the position. The module code specifies the name of the module stored beforehand. The kind of the module selected using the module table is shown in the column 1003 of the kind of the module. In this embodiment, either the event processing module, the HTML module or the device driver is identified. Incidentally, the alphabet of the first character of the module code corresponds to the kind of the module. Data registered in the column 1005 of the processing, the column 1011 of the camera, the column 1013 of the GPS, the column 1015 of the fingerprint authentication, and the column 1021 of the position represents conditions to select a module. The data “-” represents that any condition is not set. That is, each record corresponds to a set of the conditions when the module identified by the module code is selected. In this embodiment, the user's position is “general employee”, and the function of mobile terminal 5 is “camera” and “GPS”, and the designated processing is “travel expense settlement application” and “commodity purchase settlement application”. Therefore, the module codes “E112” and “H112” for which the “travel expense settlement application” and the “GPS” function are designated as conditions, the module codes “E211” and “H211” for which the “commodity purchase settlement application” is designated as a condition, and the module code “D002” for which the “GPS” function is designated as a condition are conformed with the conditions. Then, the module selector 733 stores information on the module codes conformed with the conditions into the module information storage 735.

The module extractor 737 reads out data of the modules specified by the module codes stored in the module information storage 735 from the device driver storage 739 (step S71). The data of the device driver modules is stored into the device driver storage 739 beforehand so as to correspond to the module code. In this embodiment, when the module extractor 737 finds out the module code that starts, for instance, from “D” referring to the module information storage 735, it reads out data of the device driver module corresponding to the module code from the device driver storage 739, and outputs the read data to the application generator 747.

Moreover, the module extractor 737 reads out data of the modules identified by the module codes stored in the module information storage 735 from the event processing module storage 741 (step S73). The data of the event processing module is stored in the event processing module storage 741 beforehand so as to correspond to the module code. In this embodiment, when the module extractor 737 finds out the module code that starts from “E”, for instance, referring to the module information storage 735, it reads out data of the event processing module corresponding to the module code from the event processing module storage 741, and outputs the read data to the application generator 747.

Moreover, the module extractor 737 reads out data of the modules identified by the module codes stored in the module information storage 735 from the HTML module storage 743 (step S75). The data of the HTML modules is stored in the HTML module storage 743 beforehand so as to correspond to the module code. In this embodiment, when the module extractor 737 finds out the module code that starts from “H”, for example, referring to the module information storage 735, it reads out data of the HTML module corresponding to the module code from the HTML module storage 743, and outputs the read data to the application generator 747.

In addition, the module extractor 737 reads out a common module from the common module storage 745, and outputs the read data to the application generator 747 (step S77). Modules necessary regardless of the user attributes, the functions that the mobile terminal has, and the kinds of the designated processings, such as modules like browser function modules to execute the application, for example, is stored in the common module storage 745 beforehand.

Incidentally, the step S71, step S73, step S75, and step S77 can be independently executed respectively, and it is possible to execute them in parallel, and also replace the execution order of them.

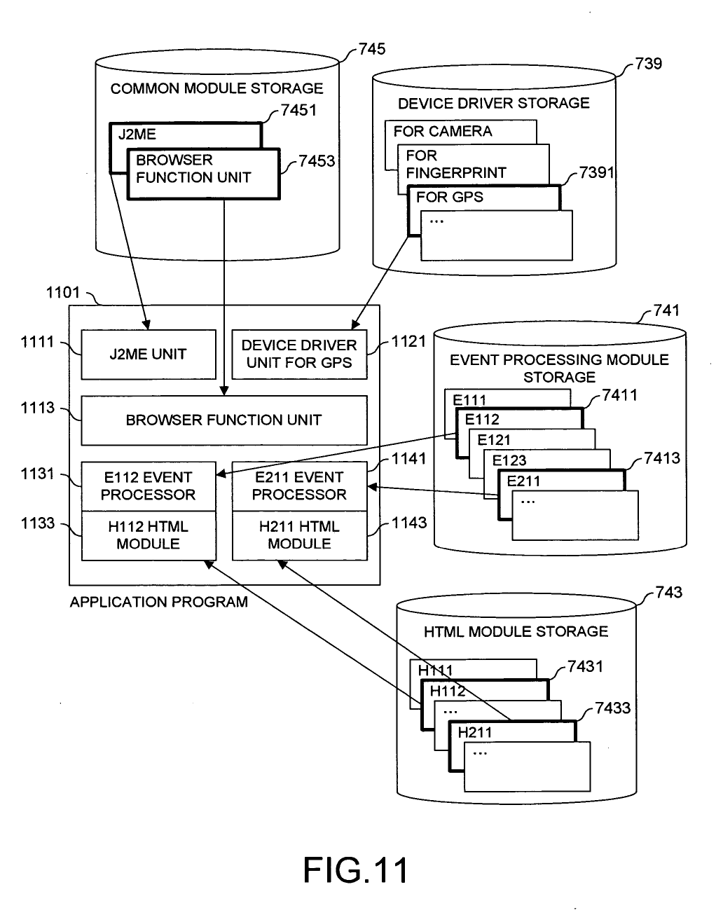

The application generator 747 receives the data of the modules from the module extractor 737, and generates an application program (step S79). A processing in the application generator 747 is explained using FIG. 11. The application generator 747 receives the device driver 7391 for the GPS, which is extracted from the device driver storage 739, the E112 module 7411 and the E211 module 7413, which are extracted from the event processing module storage 741, the H112 module 7431 and the H211 module 7433, which are extracted from the HTML module storage 743, and the module 7451 of J2ME (Java 2 Micro Edition: a trademark of Sun Microsystems, Inc.), and the module 7453 of the browser function unit, which are extracted from the common module storage 745. Next, it generates the application program by using the received various files. The application program in this embodiment is a JAR (Java Archive) file in which all necessary modules to execute the application are gathered together into a single file, for instance. The JAR file is generated by instructing the “JAR” command of JAVA, which is a well-known technique, for instance. The generated application program 1101 is a single executable file that has the J2ME unit 1111, the browser function unit 1113, the device driver unit 1121 for GPS, the E112 event processor 1131, the H112 HTML module 1133, the E211 event processor 1141, and the H211 HTML module 1143, for instance. Then, the application generator 747 stores the application program 1101 to the application storage 751, and notifies the generation completion of the application program to the generation notification unit 749.

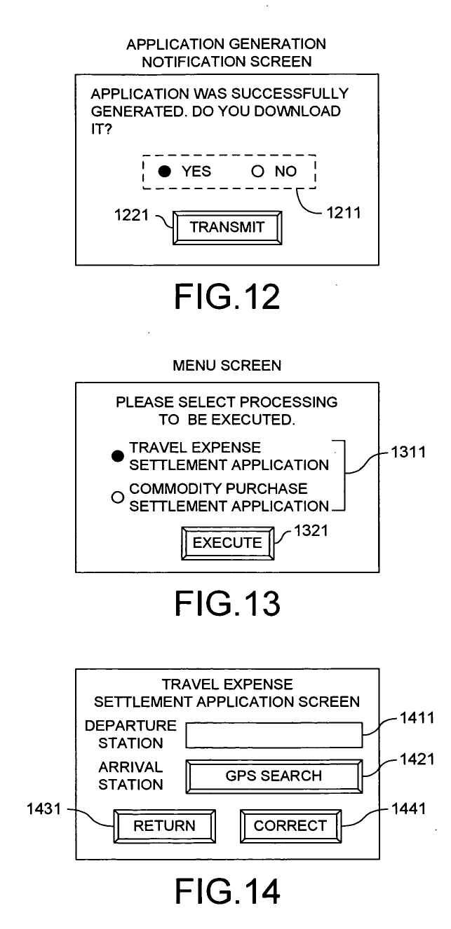

Returning to the explanation of the processing in FIG. 5, when the generation completion is notified from the application generator 747, the generation notification unit 749 notifies the generation of the application to the mobile terminal 5 (step S19). When the mobile terminal 5 receives the generation notice from the server 7, it displays a generation notification screen by using the Web browser 55, for instance (step S21). FIG. 12 shows an example of a screen displayed at the step S21. The example of the screen in FIG. 12 prompts the user to instruct the download, and includes a selection column 1211 of the download and a “transmit” button 1221. When the user selects “YES” on the screen in FIG. 12, and clicks the transmit button 1221, the mobile terminal 5 transmits a download request of the application to the server 7 (step S23). Incidentally, when the user selects “NO”, and clicks the transmit button 1221, the mobile terminal 5 transmits information including the selection result to the server 7, for instance. In response to that, the generation notification unit 749 of the server 7 that received the information may generate a URL to download the application and may transmit the URL to the mobile terminal 5, and the mobile terminal 5 may store the received URL into the memory 57.

When the download request receiver 753 of the server 7 receives the download request of the application from the mobile terminal 5, it notifies the application sender 755 that it has received the download request of the application (step S25). The application sender 755 reads out the application data from the application storage 751, when the notice is received from the download request receiver 753, and sends the application data to the mobile terminal 5 (step S27). The mobile terminal 5 receives the application data from the server 7, and stores the received data into the memory 57 (step S29). Then, when an instruction to execute the application is accepted from the user, it executes the application stored in the memory 57 (step S31).

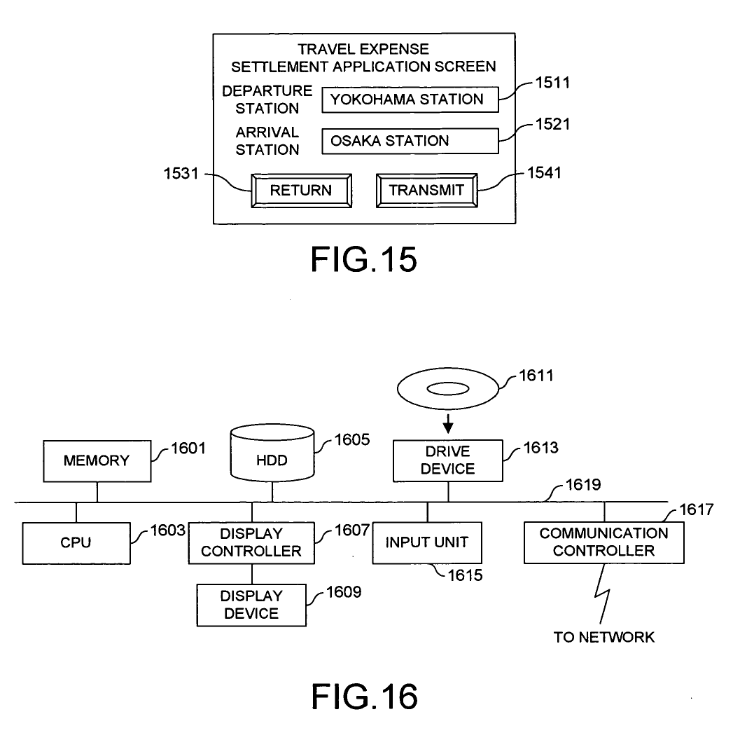

Hereafter, although it is not shown in FIG. 5, a processing to execute the application in this embodiment is explained by using FIGS. 13 to 15. The mobile terminal 5 displays a menu screen by using the Web browser 55, for instance. FIG. 13 shows an example of the menu screen. The screen example in FIG. 13 is to cause the user to select a processing to be carried when an application program to carry out plural processings designated by the user is activated, and includes a column 1311 of a processing selection, and an execute button 1321. For instance, when the user selects the “travel expense settlement application” and clicks the execute button 1321, a travel expense settlement application screen is displayed by the H112 HTML unit 1133 and the browser function unit 1113, for instance. FIG. 14 shows an example of the travel expense settlement application screen. In this embodiment, the screen example in FIG. 14 is to identify an arrival station by GPS-searching and cause the user to input a departure station, and includes a text box 1411 to input the departure station, a GPS search button 1421 to identify the arrival station, a return button 1431, and a correct button 1441. For instance, when the user clicks the GPS search button 1421, the current position is identified by the E112 event processor 1131, the device driver unit 1121 for GPS, and the GPS 53, and the arrival station specified from the current position is displayed by the browser function unit 1113, for example. FIG. 15 shows an example of a screen in which the input of the departure station was accepted from the user and the arrival station was identified. This screen example represents a case where the arrival station is identified as the Osaka Station and the departure station is input as the Yokohama Station, and includes information 1511 of the input departure station, information 1521 of the identified arrival station, a return button 1531, and a transmit button 1541. When the transmit button 1541 is clicked, the information including the information 1511 of the departure station and the information 1521 of the arrival station is transmitted to the server 7.

As described above, according to this embodiment, it is possible to generate an application program conforming with the functions of the mobile terminal, the user attributes, and the processing designation.

Although the embodiment of this invention has been explained above, this invention is not limited to the aforementioned embodiment. For instance, the functional blocks in the server 7 shown in FIG. 2 does not necessarily correspond to actual program modules, respectively. Moreover, the server 7 may be composed of plural computers.

Moreover, examples of tables shown in FIGS. 3, 4, and 10 may include other columns not shown in the figure, and the column that holds data that may not be used for the processing is omissible. In this embodiment, for instance, although a processing like selecting the module is carried out after the function corresponding to the model name is identified, it is also possible to include a column showing the model name in the module table instead of a column showing the function, and select a module by using the model name as a condition.

Moreover, the data used to select the module is not limited to data shown in this embodiment, and other information inputted by the user and information held by the mobile terminal in advance may be additionally transmitted to use the information to select the modules. For instance, inputs other than the processing designation such as an input of information (e.g. password) to authenticate the user may be further accepted from the user in the step S9, and the input information may be further included in the message body 8101. In addition, an application to cause to transmit other information held by the mobile terminal 5 beforehand may be used. For instance, when data of the processing designation page received at the step S7 is not data of HTML but data including an application program such as a Java applet, the application program may read out information representing a dynamic state of the mobile terminal 5, such as the state of the radio wave, and the capacity of the chargeable battery, and may send the read information.

Moreover, although the application is composed of the combination of the device driver, the event processing module, the HTML module, and the common module in this embodiment, the function allotment method of the modules used for the application generation is not limited to such a form. For instance, the event processing module and the HTML module may be integrated into one module. Oppositely, the event processing module may be divided into small sub-modules. Moreover, the application generator 747 may select one conforming with the conditions from among the application programs that has been generated and stored beforehand instead of generating the application program every time the application request is received.

Incidentally, the usage of this invention may not be limited to the generation of the application for the business use, and this invention is applicable for other usages like the generation of a game software, contents or the like. In addition, although the mobile terminals such as the cellular phone and PDA (Personal Data Assistants) are main targets in this embodiment, other terminals that have the communication function, for instance, home appliances that have the communication function with the Internet may be targets. According to circumstances, a normal personal computer may be used.

Incidentally, aforementioned server 7 is a computer device. That is, a memory 1601 (storage device), a CPU 1603 (processor), a hard disk drive (HDD) 1605, a display controller 1607 connected to a display device 1609, a drive device 1613 for a removal disk 1611, an input device 1615, and a communication controller 1617 for connection with a network are connected through a bus 1619 as shown in FIG. 16. An operating system (OS) and an application program for carrying out the foregoing processing in the embodiment, are stored in the HDD 1605, and when executed by the CPU 1603, they are read out from the HDD 1605 to the memory 1601. As the need arises, the CPU 1603 controls the display controller 1607, the communication controller 1617, and the drive device 1613, and causes them to perform necessary operations. Besides, intermediate processing data is stored in the memory 1601, and if necessary, it is stored in the HDD 1605. In this embodiment of this invention, the application program to realize the aforementioned functions is stored in the removal disk 1611 and distributed, and then it is installed into the HDD 1605 from the drive device 1613. It may be installed into the HDD 1605 via the network such as the Internet and the communication controller 1617. In the computer as stated above, the hardware such as the CPU 1603 and the memory 1601, the OS and the necessary application program are systematically cooperated with each other, so that various functions as described above in details are realized.

Moreover, the aforementioned mobile terminal 3 and mobile terminal 5 are computer devices. For instance, there is a case where it has a similar hardware configuration to FIG. 16, and there is also a case where the flash memory or the like is installed in place of the HDD1605 and the drive device 1613 for the removable disk 1611.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. An information processing method, comprising:
if an application program request including model identification information is received from a terminal, selecting a module for a terminal of a model specified by said model identification information based on a model selection condition;
extracting data for the selected module from a module storage;
generating an application program by using the extracted data for the selected module; and
transmitting the generated application program to said terminal.

2. The information processing method as set forth in claim 1, wherein said application program request includes information to identify a processing to be carried out by said application program, and said module selection condition includes a module selection condition for a processing to be carried out by said application program, and said selecting comprises selecting a module that conforms with said information to identify said processing to be carried out by said application program, which is included in said application program request, based on said module selection condition for said processing to be carried out by said application program.

3. The information processing method as set forth in claim 1, wherein said application program request includes identification information of a user of said terminal, and said module selection condition includes a module selection condition for a user attribute, and said selecting comprises referring to a user information storage storing an user attribute for each user to identify a user attribute corresponding to said identification information of said user of said terminal, which is included in said application program request; and selecting a module that conforms with the identified user attribute, based on said module selection condition for said user attribute.

4. The information processing method as set forth in claim 1, wherein said module selection condition includes a module selection condition for a function that a terminal has, and said selecting comprises:
referring to a model information storage storing information concerning a function that a terminal has for each model to identify a function that said terminal of said model identified by said model identification information has; and selecting a module that conforms with the identified function, based on said module selection condition for said function that said terminal has.

5. The information processing method as set forth in claim 1, wherein said extracted data for the selected module is at least either of an interface program to utilize a function that said terminal has, page data used for a screen display in said terminal, and a processing program to process information input to said terminal.

6. The information processing method as set forth in claim 1, wherein said generating comprises combining the extracted data for the selected module and data of a common module for a processing common to each application program to generate one file.

7. An information processing method, comprising:
if an application program request including identification information of a user of a terminal is received from said terminal, referring to a user information storage storing a user attribute for each user to identify a user attribute corresponding to said identification information of said user of said terminal, which is included in said application program request;
selecting a module that conforms with said user attribute of said user of said terminal, based on a module selection condition;
extracting data for the selected module from a module storage;
generating an application program by using the extracted data for the selected module; and
transmitting the generated application program to said terminal.

8. An information processing method executed by a client terminal, comprising:
transmitting an application program acquisition request including a designation of a processing to be carried out by an application program, identification information of a model of said client terminal, and identification information of a user of said client terminal, to a server;
receiving from said server, an application program to carry out the designated processing, which conforms with a model identified by said identification information of said model of said client terminal, and a user attribute identified by said identification information of said user of said client terminal; and
executing the designated processing by using a function that said client terminal has and is identified by said model, by said received application program.

9. A program embodied on a medium for causing a computer to execute an information processing, said program comprising:
if an application program request including model identification information is received from a terminal, selecting a module for a terminal of a model specified by said model identification information based on a model selection condition;
extracting data for the selected module from a module storage;
generating an application program by using the extracted data for the selected module; and
transmitting the generated application program to said terminal.

10. A program embodied on a medium for causing a computer to execute an information processing, said program comprising:
if an application program request including identification information of a user of a terminal is received from said terminal, referring to a user information storage storing a user attribute for each user to identify a user attribute corresponding to said identification information of said user of said terminal, which is included in said application program request;
selecting a module that conforms with said user attribute of said user of said terminal, based on a module selection condition;
extracting data for the selected module from a module storage;
generating an application program by using the extracted data for the selected module; and
transmitting the generated application program to said terminal.

11. An information processing apparatus, comprising:
a unit that receives an application program request including model identification information from a terminal;
a unit that selects a module for a terminal of a model specified by said model identification information based on a model selection condition;
a unit that extracts data for the selected module from a module storage;
a unit that generates an application program by using the extracted data for the selected module; and
a unit that transmits the generated application program to said terminal.

12. An information processing apparatus, comprising:
a unit that receives an application program request including identification information of a user of a terminal from said terminal;
a unit that refers to a user information storage storing a user attribute for each user to identify a user attribute corresponding to said identification information of said user of said terminal, which is included in said application program request;
a unit that selects a module that conforms with said user attribute of said user of said terminal, based on a module selection condition;
a unit that extracts data for the selected module from a module storage;
a unit that generates an application program by using the extracted data for the selected module; and
a unit that transmits the generated application program to said terminal.
